(19) United States
(12) Patent Application Publication
(10) Pub. No.: US 2026/0218541 A1
(43) Pub. Date: Jul. 30, 2026

(54) LOCKING LATCH

(71) Applicant: Kason Industries, Inc., Newnan, GA (US)

(72) Inventors: Brian Grewe, Winston, GA (US); Brett A. Mitchell, Newnan, GA (US)

(73) Assignee: Kason Industries, Inc., Newnan, GA (US)

(21) Appl. No.: 19/041,188

(22) Filed: Jan. 30, 2025

(51) Int. Cl. E05B 13/00

(52) U.S. Cl. CPC E05B 13/002

(57) ABSTRACT

A latch includes a main housing having a handle coupled to an actuator cam for pivotal movement. The actuator cam has camming lobe. The latch also has a link plate that has top cam following surface, a pair of collars, and a downwardly depending finger. The link plate is coupled to the main housing for movement through two round guide rods. A compression spring is mounted about each guide rod. The latch also includes a side slider coupled to the main housing for reciprocal, linear and lateral movement between an unlocked position and an unlocked position. The side slider has a slide plate having a finger notch configured to receive the finger when the side slider is in its unlocked position and the link plate is moved downwardly to its unlatched position which the door to be opened. The side slider also includes a pivotable lever that engages a lock.

### TECHNICAL FIELD

This invention relates generally to door latches, and more particularly to the latch used for commercial refrigerator and freezer doors.

### BACKGROUND OF INVENTION

Walk-in cold rooms, such as walk-in coolers, freezers, or other refrigerated environments, are common in various industries, including supermarkets and grocery stores, commercial kitchens, and other food service facilities. They typically have one or more access doors for entry and exit from the environment.

A problem associated with a cold-room door is the possibility that a person may become enclosed within the cold-room. To resolve this potential problem the door is provided with an inside release designed to release the latch on the opposite side of the door. The inside release may be in the form of a knob having a threaded rod which mounts the latch to the cold room door. A problem with this type of device is that a person in a panicked state within the cold room may not realize that turning the internal knob releases the latch and allows egress from the cold-room.

Another problem with these types of releases is that some people may not have the hand strength or dexterity to turn a tightened knob type release.

Some bar type latches have been designed which allow a person to simply push upon an elongated horizontal bar to operate a latch. These types of bar latches operate by directly actuating the release mechanism of the latch, i.e., the bar is directly coupled to the strike which prevents the opening of the door. This type of bar latch is shown in U.S. Pat. Nos. 5,947,534; 5,547,235; 3,897,092, and 2,320,298. These types of bar latches directly operate the strike through linkage which may become inoperable over time due to wear.

Another problem associated with these rooms is that refrigerator door is intended to be locked to prevent the theft of goods contained within the refrigerator. As such, the outside latch is oftentimes provided with a locking mechanism to prevent the opening of the door to prevent theft.

Many latches are provided with a complexity of gear-driven mechanisms to lock the latch. These gear-driven mechanisms increase the risk of latch failure as the small gears are prone to breaking due to wear, misalignment, or broken teeth as a result of fatigue, improper installation, or faulty repairs. This failure can cause the locking mechanism to bind or prevent the latch from locking or unlocking properly. Furthermore, these mechanisms rely of rotational movement to change motion and use spring pressure to maintain components in the proper position. The failure of these rotational or spring pressure components can allow gravity to shift the component out of position or cause them to disengage entirely.

Accordingly, there is a need in the art for a latch that will allow for the door to be latched and locked within causing excessive wear or the use of gear driven components. It is to the provision of such therefore that the present invention is primarily directed.

### SUMMARY OF THE INVENTION

In a preferred form of the invention a latch comprises a housing, a handle pivotally coupled to the housing for movement between a latched position and an unlatched position, an actuation cam coupled to the handle for reciprocal rotary movement between a latch position and an unlatched position, the actuation cam having a camming surface, a link plate coupled to at least two vertically extending guide rods for reciprocal vertical movement along the guide rods, the link plate having a cam contacting top surface and a portion with a bottom surface, a spring biasing the link plate upwardly along the guide rods, a side slider coupled to the housing for reciprocal lateral and linear movement relative to the housing between an unlocked position wherein the link plate bottom surface does not movably contact the side slider to allow the downward movement of the link plate and a locked position wherein the link plate bottom surface abuts the side slider to prevent the downward movement of the link plate and thus preventing the pivoting of the handle from the latched position to the unlatched position, and a lock configured to engage and forcibly move the side slider between its unlocked position and the locked position.

### BRIEF DESCRIPTION OF DRAWINGS

FIG. 1 is a front, perspective view of a locking latch embodying principles of the invention in a preferred form.

FIG. 2 a rear, perspective view of the locking latch of FIG. 1 in a locked configuration and the handle in an unbiased, latched position, shown with the rear closeout plate removed for clarity of explanation.

FIG. 3 a rear, perspective view of the locking latch of FIG. 1 in an unlocked configuration and the handle in a biased, unlatched position, shown with the rear closeout plate removed for clarity of explanation.

FIG. 4 a rear view of the locking latch of FIG. 1 in an unlocked configuration and the handle in an unbiased, latched position, shown with the rear closeout plate removed for clarity of explanation.

FIG. 5 a rear view of the locking latch of FIG. 1 in an unlocked configuration and the handle in a biased, unlatched position, shown with the rear closeout plate removed for clarity of explanation.

FIG. 6 a rear view of the locking latch of FIG. 1 in a locked configuration and the handle in an unbiased, latched position, shown with the rear closeout plate removed for clarity of explanation.

FIG. 7 a rear view of the locking latch of FIG. 1 in an unlocked configuration and the handle in an unbiased, latched position, shown with the rear closeout plate removed for clarity of explanation and the handle mounted on the opposite side as compared to FIGS. 1-6.

### DETAILED DESCRIPTION

With reference next to the drawings, there is shown a latch 10 according to the present invention. The latch 10 is mounted to the exterior or outside surface of a door D of a walk-in cold room within a surrounding wall to control and/or restrict opening of the door D and access the walk-in cold room.

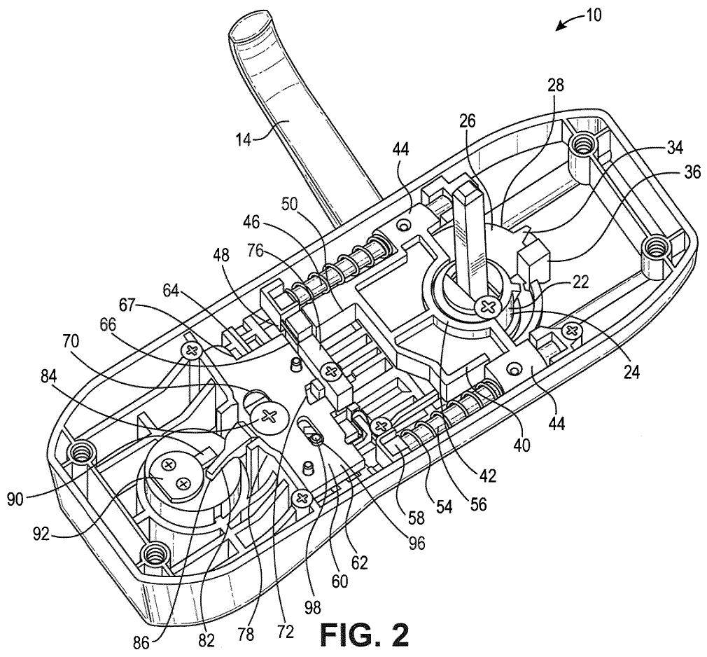

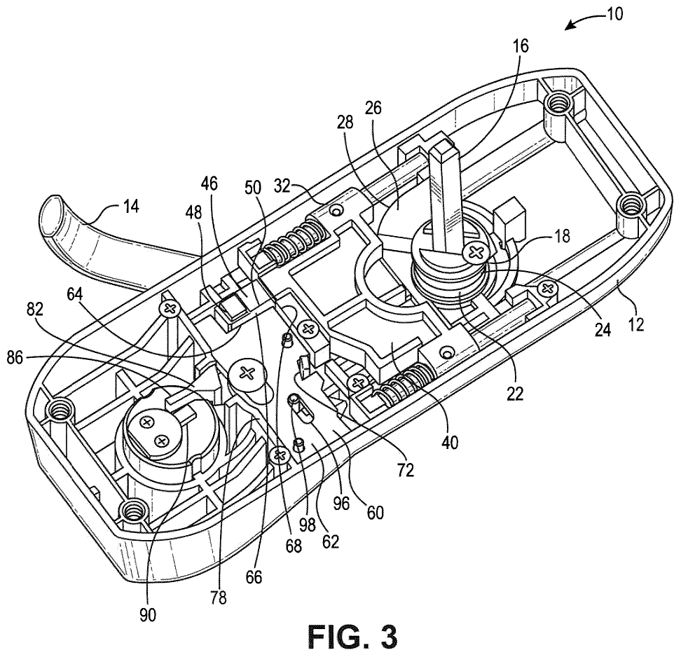

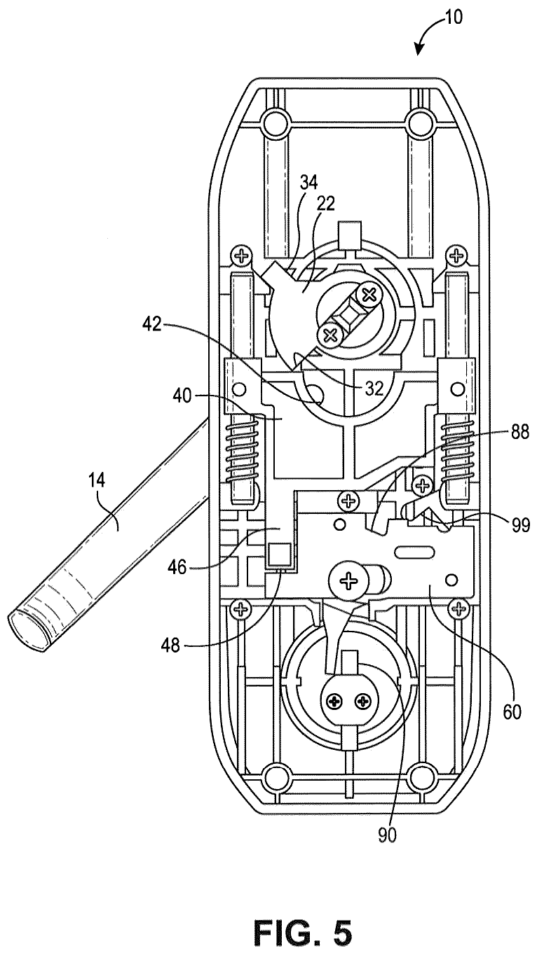

The latch 10 includes a main housing 12 having a lever type handle 14 pivotally coupled to the housing 12. The handle 14 has a portion extending through an opening in the main housing 12 and a square-shaped rotating spindle or rod 16. The handle 14 is fixedly coupled to an actuator cam 22 for pivotal movement of the actuator cam 22 between a latched position shown in FIGS. 2, 4, 6, and 7 and an unlatched position shown in FIGS. 3 and 5 through the pivotal movement of the handle 14. The actuator cam 22 has an annular seat 24 from which extends a camming lobe 26. The camming lobe 26 has a contact surface 28 having an outboard or outmost camming edge 32. The camming lobe 26 also has a stop wall, portion, or surface 34 oppositely disposed from the camming edge 32. The stop wall 34 is configured and positioned to abut a stop, stop wall, or stop portion 36 of the main housing 12 to limit pivotal movement when the latch is in its latched position.

The latch 10 includes a link body or link plate 40 that is coupled to the main housing 12 for reciprocal, linear and vertical movement between a latched position shown in FIGS. 2, 4, 6, and 7 and an unlatched position shown in FIGS. 3 and 5. The link plate 40 has a semi-circular cut-out or receiver 42 that is configured to contour about the annular seat 24 of the actuator cam 22. The cut-out 42 is flanked on both sides by a pair of top cam following or bearing surfaces 43 and a pair of cylindrical riders or collars 44. The link plate 40 also has a downwardly depending portion, finger, finger portion, or member 46 having a first contact surface or bottom surface 48 and a side surface 50.

The link plate 40 is reciprocally coupled to the main housing 12 for linear, vertical movement through two round guide rods 54 that are journaled through the two collars 44 of the link plate 40. A compression spring 56 is mounted about each guide rod 54 between a collar 44 and the lower end 58 of the guide rod 54 that biases the link plate 40 upwardly towards the actuation cam 22 to the latched position against the actuator cam 22.

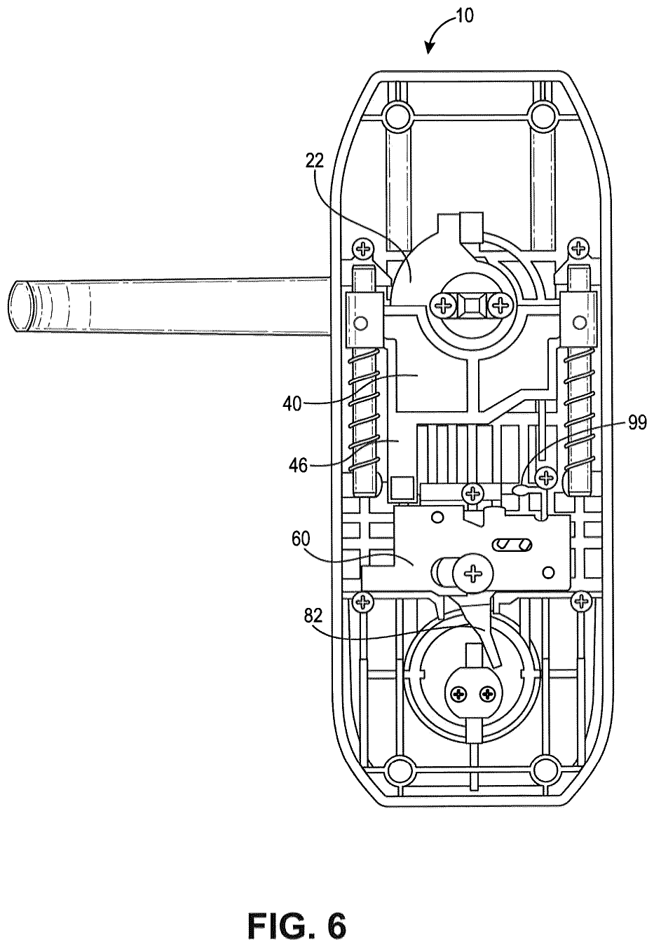

The latch 10 also includes a linear slide block or side slider 60 coupled to the main housing 12 for reciprocal, linear and lateral movement between an unlocked position shown in FIGS. 3, 4, 5 and 7 and an unlocked position shown in FIGS. 2 and 6. The side slider 60 has a slide plate 62 having a finger recess or notch 64 extending from a top surface 66 that is configured to receive the finger 46 of the link plate 40 when the side slider 60 is in its unlocked position and the link plate 40 is moved downwardly to its unlatched position when the door to be opened, as best shown in FIGS. 3 and 5. The notch 64 has a top surface or edge 67 and a side surface or edge 68. The top edge 67 contacts the bottom surface 48 of the finger 46 while the side edge 68 contacts the side surface 50 of the finger 46 when the link plate 40 is in its unlatched position. The top surface 66 is positioned closely adjacent to or in abutment with the bottom surface 48 of the finger 46 when the side slider 60 is in its locked position, as shown in FIGS. 2 and 6.

The slide plate 62 has an elongated mounting slot 70 and a top recess 72 extending from the top surface 66. The slide plate 62 is positioned within a slide channel 74 between a top guide wall 76 and a bottom guide wall 78 to help to guide the slide plate 62 in a lateral direction. The side slider 60 also includes a pivotable switching lock lever, pawl or trigger 82. The side slider 60 is reciprocally coupled to the main housing 12 through a pivot or mounting screw 84 passing through elongated mounting slot 70 of the slide plate 62 and through an unshown mounting hole in the lock lever 82 and into an unshown threaded mounting hole in the housing 14. The lock lever 82 has a bottom end 86 and an oppositely disposed top end or tang 88 that resides within the top recess 72 of the slide plate 62. The bottom end 86 of the lock lever 82 is configured to engage an engagement bar 90 of a rotating cylindrical lock 92 coupled to the main housing 12. The rotational pushing movement of the lock engagement bar 90 upon the bottom end 86 of the lock lever 82 results in the pivotal movement of the top end or tang 88 within the top recess 72 resulting in the sideways linear and lateral movement of the side plate 62 of the side slider 60 between its locked position of FIGS. 2 and 6 and unlocked position of FIGS. 3, 4, 5, and 7.

The side slider 60 also includes an elongated guide slot 96 that receives a guide pin 98 of the housing 12 to help guide the lateral movement of the side slider 60 while supporting the guide plate 62 upon the main housing 12. A leaf spring 99 bears against the top surface 66 to help maintain the slide plate 62 in a proper position while moving. A back plate 100 is mounted to the housing 14 to encase or enclose the latch components within the main housing 12 and back plate 100, as such, the back plate 100 may also be considered to be part of the main housing 12.

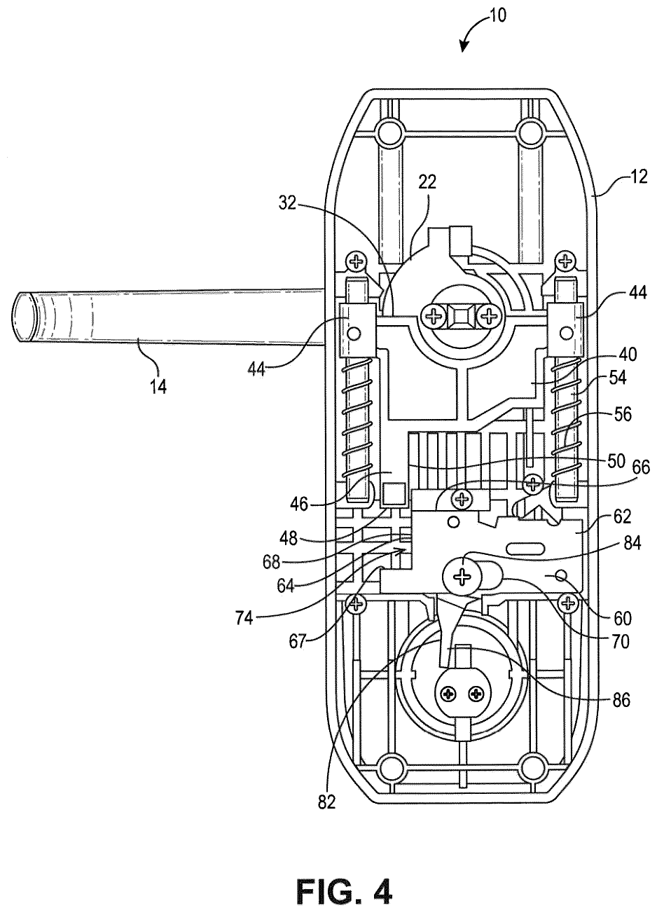

In use, the latch 10 is mounted to the door D of a walk-in cold room. The directional position of the handle 14 and the actuator cam 22 coupled thereto is determined by the direction of door opening shown by comparing FIG. 4 to FIG. 7. It should be understood that the current latch 10 is ambidextrous as the handle 14 and actuator cam 22 may be simply flipped to either position depending on the direction of door opening.

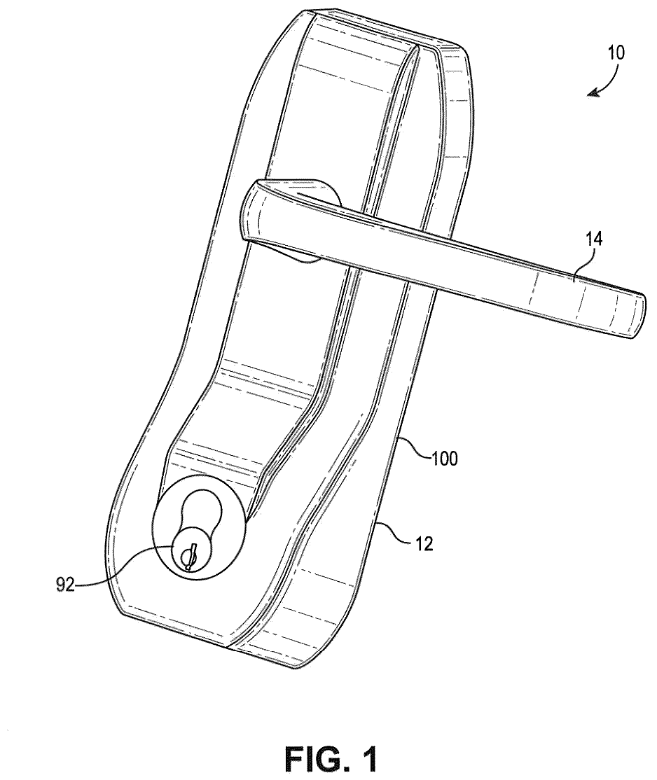

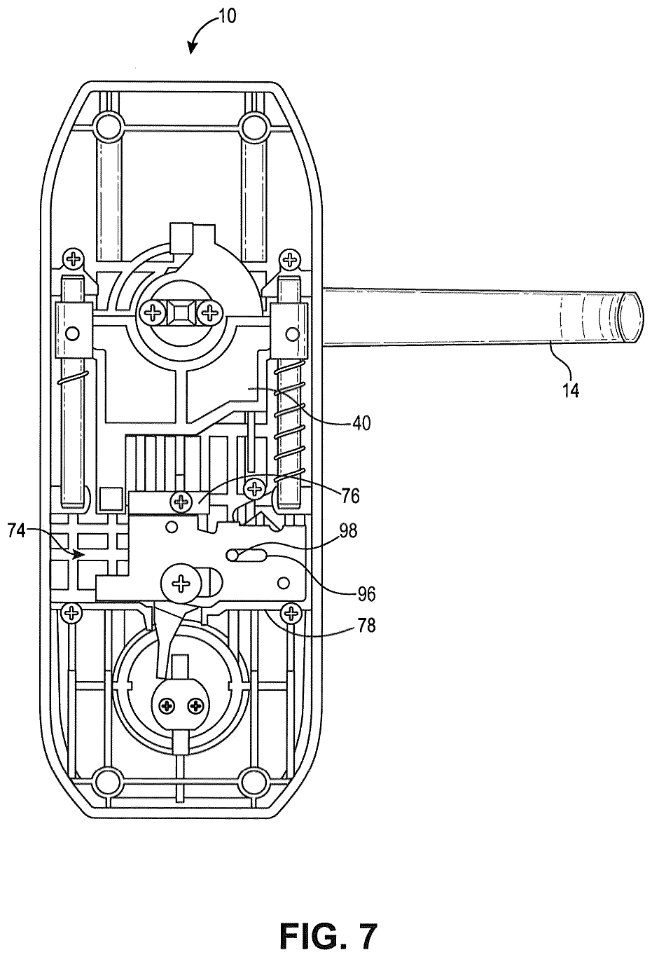

With the latch 10 mounted to the door D, the neutral position of the latch 10 is to have the handle 14 in a latched position, shown in FIGS. 1, 2, 4 and 6. Typically, the latch 10 is also in an unlocked position shown in FIGS. 4 and 7.

To open the door D with the lock 92 in an unlocked position, the handle 14 is pivoted or rotated from its latched position in FIG. 4 to its unlatched position in FIG. 5. This rotational movement of the handle 14 causes the actuator cam 22 to rotate, thereby causing the camming edge 32 of the actuator cam 22 to bear against the top cam bearing surface 43 of the link plate 40 resulting in the downward, vertical and linear movement of the link plate 40. The movement of the link plate 40 is insured by the journaled movement of the link plate collars 44 along the guide rods 54. This downward movement causes the compression springs 56 upon the guide rods 54 to be compressed between the collars 44 and the lower end 58 creating an upward biasing force through the compression springs 56 upon the link plate 40. The mounting of the link plate 40 to the guide rods 54 is an advantage over the prior art as it maintains a great strength of the latching components while delivering a very straight path of travel for the link plate 40 to reduce wear over time and use.

Upon the release of the handle 14 by an operator, the spring force of the compression springs 56 return the actuator cam 22 and handle 14 to their neutral, latched position. Thus, the spring force of the compression springs 56 upon guide rods 54 forces the link plate 40 upwardly returning the link plate 40 to a position wherein the receiver 42 is positioned against and partially about the annular seat 24 of the actuator cam 22.

The latch 10 may be reconfigured to a locked condition by rotating the cylinder lock 92, clockwise in FIGS. 2-7, to a locked position while the handle 14 is in its neutral, unlatched position. The clockwise rotation of the cylinder lock 92 causes the engagement bar 90 to rotate clockwise resulting in the engagement bar 90 pushing the bottom end 56 of the lever 82 towards the right to the locked position shown in FIGS. 2 and 6. This rightward movement of the bottom end 56 causes pivotal or rotational movement of the entire lever 82 about mounting screw 84 and the leftward movement of the oppositely disposed top end or tang 88. As the top end 88 moves leftwardly it pushes upon the slide plate 62 thereby causing the slide plate 62 to laterally move in a leftward direction to its locked position shown in FIGS. 2, 5, and 6. With the slide plate 62 in its locked position, the unlatching movement of the handle 14 is prevented from occurring as the slide plate 62 prevents the downward movement of the link plate 40 as the bottom surface 48 of the finger 46 now abuts against the top surface 66 of the slide plate 62. Thus, the abutment between the link plate 40 and the side slider 60 prevents the rotation of the handle 14 and the unlatching of the door D.

In order to unlock a locked latch, the cylinder lock 92 is rotated counter-clockwise so that the engagement bar 90 pushes the bottom end 57 of the lever towards the left and to its unlocked position. Now, the slide plate 62 is moved through the lever movement towards the right and returned to its unlocked position.

It should be understood that mounting the link plate 40 to the stationary guide rods 54 provides an extremely stable construction to avoid wear. This arrangement also moves the link plate 40 linearly as well as moving the slide plate 62 linearly to avoid the problems associated with rotational movement of these force bearing components.

It should be understood that the meshing or residing of the finger 46 and the notch 64 provides more stability to these sliding components as it produces an elongated contacting surface between these components.

While this invention has been described in detail with particular reference to the preferred embodiments thereof and the best mode of practicing same, it will be understood that variations and modifications can be affected within the spirit and scope of the invention as described herein above and as set forth in the appended claims.

1. A latch comprising,
a housing;
a handle pivotally coupled to said housing for movement between a latched position and an unlatched position;
an actuation cam coupled to said handle for reciprocal rotary movement between a latch position and an unlatched position, said actuation cam having a camming surface;
a link plate coupled to at least two vertically extending guide rods for reciprocal vertical movement along said guide rods, said link plate having a cam contacting top surface and a portion with a bottom surface;
a spring biasing said link plate upwardly along said guide rods;
a side slider coupled to said housing for reciprocal lateral and linear movement relative to said housing between an unlocked position wherein said link plate bottom surface does not movably contact said side slider to allow the downward movement of said link plate and a locked position wherein said link plate bottom surface abuts said side slider to prevent the downward movement of said link plate and thus preventing the pivoting of said handle from said latched position to said unlatched position, and
a lock configured to engage and forcibly move said side slider between its unlocked position and said locked position.

2. The latch of claim 1 wherein said side slider includes a lateral and linear moving side plate and a pivotal lever coupled to said side plate and engageable with said lock.

3. The latch of claim 2 wherein said pivotal lever has a top end configured to engage said side plate, a bottom end configured to engage said lock, and a pivot positioned between said top end and said bottom end.

4. The latch of claim 1 wherein said actuation cam has an annular seat positioned about a portion of said handle and a camming lobe extending from said annular seat, said camming lobe including said camming surface.

5. The latch of claim 1 wherein said link plate includes two oppositely disposed collars wherein each collar is journalled upon one guide rod.

6. The latch of claim 1 wherein said housing includes a slide channel defined by two spaced apart guide walls, and wherein said side slider is positioned within said channel for guided reciprocal movement of said side slider.

7. The latch of claim 2 wherein said lock is a rotatable lock having an engagement bar configured to engage said pivotal lever.

8. The latch of claim 1 wherein said link plate has an elongated finger portion and wherein said side slider includes a notch configured to receive said finger portion.

9. A latch comprising,
a housing;
a handle pivotally coupled to said housing for movement between a latched position and an unlatched position;
an actuation cam fixedly coupled to said handle so that pivotal movement of said handle cause pivotal movement of said actuation cam;
a link plate coupled to said housing for reciprocal linear movement relative to said housing between a latched position and an unlatched position, said link plate having a cam following surface in contact with said actuation cam, said link plate also having a portion with a first contact surface;
a spring biasing said link plate towards said latched position of said link plate;
a side slider coupled to said housing for reciprocal lateral and linear movement relative to said housing between an unlocked position wherein said first contact surface of said link plate does not contact said side slider to allow the downward movement of said link plate and a locked position wherein said first contact surface of said link plate abuts said side slider to prevent the downward movement of said link plate and thus prevents the pivoting of said handle from said latched position to said unlatched position, and
a lock configured to engage and forcibly move said side slider between its unlocked position and said locked position.

10. The latch of claim 9 further comprising a pair of guide rods and wherein said link plate coupled to said guide rods for reciprocal linear movement along said guide rods.

11. The latch of claim 9 wherein said side slider includes a lateral and linear moving side plate and a pivotal lever coupled to said side plate and engageable with said lock.

12. The latch of claim 11 wherein said pivotal lever has a top end configured to engage said side plate, a bottom end configured to engage said lock, and a pivot positioned between said top end and said bottom end.

13. The latch of claim 9 wherein said actuation cam has an annular seat positioned about a portion of said handle and a camming lobe extending from said annular seat, said camming lobe including a camming surface contacting said link plate.

14. The latch of claim 10 wherein said link plate includes two oppositely disposed collars wherein each collar is journalled upon one guide rod.

15. The latch of claim 9 wherein said housing includes a slide channel defined by two spaced apart guide walls, and wherein said side slider is positioned within said channel for guided reciprocal movement of said side slider.

16. The latch of claim 11 wherein said lock is a rotatable lock having an engagement bar configured to engage said pivotal lever.

17. The latch of claim 9 wherein said link plate has an elongated finger portion and wherein said side slider includes a notch configured to receive said finger portion.
